(19) United States
(12) Patent Application Publication
(10) Pub. No.: US 2007/0014288 A1
(43) Pub. Date: Jan. 18, 2007

(54) Apparatus and method for point-to-point emulation in a broadband wireless communication system

(75) Inventors: Se-Youn Lim, Seoul (KR); Kug Shin, Seoul (KR); Young-Jun Park, Seoul (KR); Hyun-Ok Kim, Osan-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/487,185

(22) Filed: Jul. 14, 2006

(30) Foreign Application Priority Data
Jul. 14, 2005 (KR) 2005-0063608

(51) Int. Cl. H04L 12/56; H04J 3/16

(52) U.S. Cl. 370/389; 370/469

(57) ABSTRACT

A point-to-point emulation apparatus and method in a broadband wireless communication system are provided. In a communication method in an RAS in a broadband wireless communication system, an ID of a source terminal and an ID of a destination terminal are registered in a database by mapping the ID of the source terminal to the ID of the destination terminal, for communications between terminals registered to the RAS. Upon receipt of traffic data from the source terminal, a header of the traffic data is converted using the database, for transmission to the destination terminal on a downlink.

### PRIORITY

This application claims priority under 35 U.S.C. § 119 to an application entitled “Apparatus and Method for Point-to-Point Emulation in a Broadband Wireless Communication System” filed in the Korean Intellectual Property Office on Jul. 14, 2005 and assigned Serial No. 2005-63608, the contents of which are herein incorporated by reference.

### BACKGROUND OF THE INVENTION

1. Field of the Invention

The present invention relates generally to a point-to-point emulation apparatus and method in a broadband wireless communication system, and in particular, to an apparatus and method for enabling users belonging to the same Radio Access Station (RAS) to communicate with each other without intervention from a higher-layer system.

2. Description of the Related Art

Along with the introduction of a cellular mobile communication system in the U.S. in the late 1970s, Korea began to implement a voice communication service by deploying a first Generation (1G) mobile communication system, Advanced Mobile Phone Service (AMPS). In the mid 1990s, a 2^{nd} Generation (2G) mobile communication system, Code Division Multiple Access (CDMA), came into use to provide voice and low-speed data service.

International Mobile Telecommunication-2000 (IMT-2000), which was introduced in the late 1990s to realize advanced wireless multimedia services, worldwide roaming, and high-speed data service, has been partially deployed at present.

Today, mobile communication technology is evolving from 3^{rd} Generation (3G) mobile communication systems to 4^{th} Generation (4G) mobile communication systems. Beyond the traditional, simple wireless communication services provided by the previous-generation mobile communication systems, the 4G systems are under standardization for the purpose of efficient interworking and integration between wireless and wired communication networks. The following description is made in the context of an International Electrical and Electronics Engineers (IEEE) 802.16 based system (e.g. Wireless Broadband (WiBro)).

FIG. 1 illustrates a hierarchical protocol architecture of a Radio Access Station (RAS) in a conventional broadband wireless communication system. The protocol stack is comprised of a PHYsical (PHY) layer 100, a Medium Access Control (MAC) layer 110, and a convergence sublayer 120.

Referring to FIG. 1, the convergence sublayer 120 converts data associated with digital audio/video multicast, digital telephony, and Internet connection in compliance with an 802.16 MAC protocol. The convergence sublayer 120 converts an Internet Protocol (IP) packet to a MAC Packet Data Unit (PDU) with a corresponding Connection Identifier (CID) and provides the MAC PDU to the MAC layer 110. The coverage sublayer 120 also converts a MAC PDU received from the MAC layer 110 to an IP packet and sends the IP packet to a higher-layer router of the RAS.

The MAC layer 110 controls access to a common wireless medium and controls flows of data and control signals according to the MAC protocol that specifies the time when the RAS or a Mobile Station (MS) starts transmission. In addition, the MAC layer 110 creates a frame with MAC PDUs received from the convergence sublayer 120 and provides the frame to the PHY layer 100. The MAC layer 110 also extracts MAC PDUs from data received from the PHY layer 100 and provides the MAC PDUs to the convergence sublayer 120.

The PHY layer 100 processes the frame data received form the MAC layer 110 by coding, modulation, Inverse Fast Fourier Transform (IFFT), and Radio Frequency (RF) modulation, for transmission on a radio link. For reception, the PHY layer 100 processes a signal received on the radio link by RF demodulation, Fast Fourier Transform (FFT), demodulation, and decoding and provides the processed signal to the MAC layer 110.

In general, an MS connected to an RAS is allocated downlink and uplink CIDs in a signaling procedure. The signal procedure results in creation of a mapping table illustrated below in Table 1.

TABLE 1

| IP address | Downlink CID | Uplink CID |
|---|---|---|
| 102.124.25.1 | 234 | 110: |
| . | . | . |
| . | . | . |
| . | . | . |

As described above, the RAS accesses the mapping table such as Table 1, acquires a downlink CID corresponding to the destination (IP address) of an IP packet to be sent to the MS (or user), and generates a MAC PDU with the downlink CID. The MAC PDU is sent to the MS via a radio link. Reversely, the RAS creates an IP packet using a MAC PDU received via the radio link and sends the IP packet to the higher-layer router.

FIG. 2 illustrates communication paths between users in the conventional broadband wireless communication system.

Referring to FIG. 2, User #1 and User #2 have been registered to a first RAS 210, while User #3 has been registered to a second RAS 220. User #1 and User #3 belonging to different RASs communicate with each other in Path #1 running between them through the first RAS 210, a router 200, and the second RAS 220. User #1 and User #2 belonging to the same RAS communicate with each other in Path #2 running between them through the first RAS 210 and the router 200. In this way, a data communication path is established between users via the router 200 (or access router).

Path #1 and Path #2 are set up in the same signaling procedure. Regarding Path #2, User #1 and User #2 perform IEEE 802.16 network entry and then a Dynamic Service Add (DSA) procedure for data transmission. During the DSA procedure, User #1 and User #2 each are allocated different downlink and uplink CIDs from the first RAS 210. It is assumed that User #1 has an uplink CID of CID100 and a downlink CID of CID200, while User #2 has an uplink CID of CID300 and a downlink CID of CID400.

User #1 first sends data to the first RAS 210 using CID 100. The first RAS 210 converts the data to an IP packet and forwards the IP packet to the router 200. The router 200 identifies the destination (User #2) of the IP packet and sends the IP packet to the first RAS 210 to which User #2 has been registered. The first RAS 210 checks the destination (User #2) of the IP packet and sends the traffic to User #2 using the downlink CID400 of User #2.

As described above, in the conventional system, when communications occur between users within the same RAS, there is no way for the RAS to find out that the communications occur within its coverage area. Thus, an inefficient communication path is established, which runs through the router above the RAS. As a consequence, unnecessary traffic is increased between the RAS and the router. The broadband wireless communication system supports up to 1 Gbps between the RAS and the MS. Hence, upon generation of unnecessary traffic, network resources are consumed as much and user-requested Service of Quality (QoS) cannot be ensured.

Considering that the broadband wireless communication network may evolve into an ad-hoc or multi-hop network, data communications may take place frequently between users within the same RAS. If the router above the RAS routes traffic to a destination, QoS cannot ensured and time delay occurs particularly to real-time traffic such as voice communication, thereby impeding service provisioning.

### SUMMARY OF THE INVENTION

An aspect of the present invention is to substantially solve at least the above problems and/or disadvantages and to provide at least the advantages below. Accordingly, an aspect of the present invention is to provide a point-to-point emulation apparatus and method for an RAS in a broadband wireless communication system.

Another aspect of the present invention is to provide an apparatus and method for enabling users within the same RAS to communicate with each other without intervention from a higher-layer system through point-to-point emulation in a broadband wireless communication system.

A further aspect of the present invention is to provide an apparatus and method for, in case of communications between users within the same RAS, sending traffic data directly to a corresponding user without forwarding the traffic data to a higher-layer router in the RAS in a broadband wireless communication system.

The above aspects are achieved by providing a point-to-point emulation apparatus and method in a broadband wireless communication system.

According to one aspect of the present invention, in a communication apparatus in an RAS in a broadband wireless communication system, a MAC layer extracts a MAC PDU from uplink data received from a physical layer and transmits the MAC PDU to an emulation layer. The emulation layer identifies a destination of the MAC PDU received from the MAC layer, and if the MAC PDU is associated with communications between terminals registered to the same RAS, the emulation layer converts a header of the MAC PDU and transmits the MAC PDU with the converted header to the MAC layer, for transmission to the destination terminal.

According to another aspect of the present invention, in a communication apparatus in an RAS in a broadband wireless communication system, a database manages an ID of a source terminal and an ID of a destination terminal for communications between terminals registered to the RAS by mapping the ID of the source terminal to the ID of the destination terminal. A header converter, upon receipt of traffic data from the source terminal, converts a header of the traffic data using the database to transmit the traffic data to the destination terminal on a downlink.

According to a further aspect of the present invention, in a communication method in an RAS in a broadband wireless communication system, an ID of a source terminal and an ID of a destination terminal are registered in a database by mapping the ID of the source terminal to the ID of the destination terminal, for communications between terminals registered to the RAS. Upon receipt of traffic data from the source terminal, a header of the traffic data is converted using the database, for transmission to the destination terminal on a downlink.

According still another aspect of the present invention, in a communication method in an RAS having a database for managing an ID of a source terminal and an ID of a destination terminal for communications between terminals registered to the same RAS by mapping the ID of the source terminal to the ID of the destination terminal, upon receipt of traffic data from a terminal, an ID is acquired from the traffic data. It is determined whether the ID is registered in the database. If the ID is registered in the database, an ID of a destination terminal to communicate with the terminal is acquired from the database. The ID of the destination terminal is written in the traffic data and the traffic data is transmitted to the destination terminal on a downlink.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a hierarchical protocol architecture of an RAS in a conventional broadband wireless communication system;

FIG. 2 illustrates communication paths between users in the conventional broadband wireless communication system;

FIG. 3 illustrates a hierarchical protocol architecture of an RAS in a broadband wireless communication system according to the present invention;

FIG. 4 illustrates the structure of a MAC PDU in an IEEE 802.16 system;

FIG. 5 illustrates the structure of a MAC header in the IEEE 802.16 system;

FIG. 6 is a detailed block diagram of a Point-To-Point Emulation (PTPE) layer according to the present invention;

FIG. 7 is a flowchart illustrating a procedure for processing a signaling message in the PTPE layer according to the present invention;

FIG. 8 is a flowchart illustrating a procedure for processing traffic in the PTPE layer according to the present invention; and

FIG. 9 illustrates communication paths between users in the broadband wireless communication system according to the present invention.

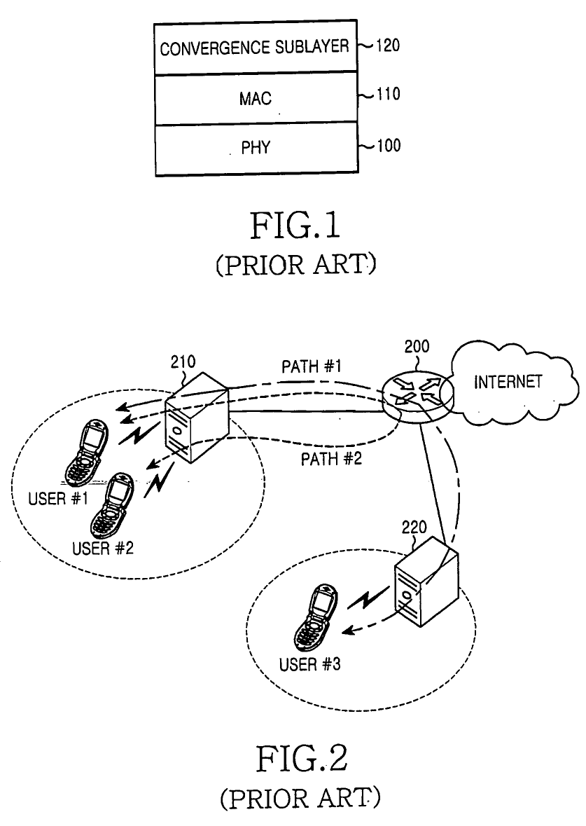

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a technique for, during communications between users registered to the same RAS or Base Station (BS), sending traffic data to a corresponding user without forwarding the traffic data to a higher-layer router by the RAS.

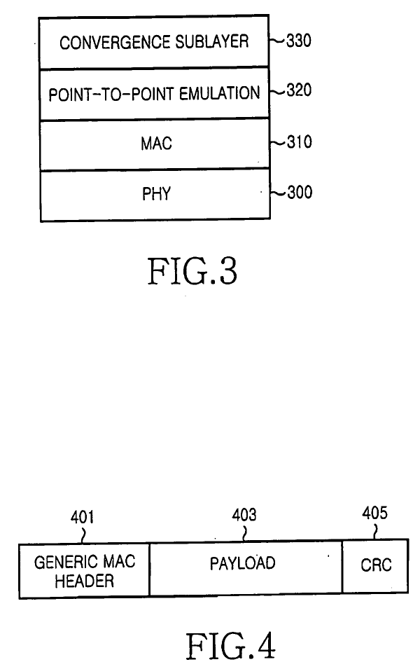

FIG. 3 illustrates a hierarchical protocol architecture of an RAS in a broadband wireless communication system according to the present invention.

Referring to FIG. 3, the protocol stack of the RAS includes a PHY layer 300, a MAC layer 310, a PTPE (Point-to-Point Emulation) layer 320, and a convergence sublayer 330.

The convergence sublayer 330 converts data associated with digital audio/video multicast, digital telephony, and Internet connection in compliance with an 802.16 MAC protocol. The convergence sublayer 330 converts an IP packet to a MAC PDU with a corresponding CID and provides the MAC PDU to the PTPE layer 320. It also converts a MAC PDU received from the PTPE layer 320 to an IP packet and sends the IP packet to a higher-layer router above the RAS.

The PTPE layer 320 preserves a mapping table (hereinafter, a PTPE table) for managing source CIDs and destination CIDs for communications between users within the same RAS. The PTPE layer 320 analyzes the header of a MAC PDU received from its lower MAC layer 310. If determining that the header is associated with communications between users within the same RAS, the PTPE layer 320 converts the MAC PDU header referring to the PTPE table and provides the MAC PDU header to the MAC layer 310. Otherwise, the PTPE layer 320 transfers the received MAC PDU to its higher layer, i.e. the convergence sublayer 330. On the other hand, the PTPE layer 320 provides a MAC PDU received form the convergence sublayer 330 to the MAC layer 310.

The MAC layer 310 controls access to a common wireless medium and controls flows of data and control signals according to the MAC protocol that specifies the time when the RAS or an MS starts transmission. In addition, the MAC layer 310 creates a frame with MAC PDUs received from the PTPE layer 320 and provides the frame to the PHY layer 300. The MAC layer 310 also extracts MAC PDUs from data received from the PHY layer 300 and provides the MAC PDUs to the PTPE layer 320.

The PHY layer 300 processes the frame data received form the MAC layer 310 by coding, modulation, IFFT, and RF modulation, for transmission on a radio link. For reception, the PHY layer 300 processes a signal received on the radio link by RF demodulation, FFT, demodulation, and decoding and provides the processed signal to the MAC layer 310.

The PTPE table designed to manage communications between users within the same RAS has the following configuration shown in Table 2.

TABLE 2

| Source CID | Destination CID |
|---|---|
| 124 | 234 |
| . | . |
| . | . |
| . | . |

In Table 2, source CID indicates the uplink CID of a source MS that sends data, and destination CID indicates the downlink CID of a destination MS.

Now a description will be made of the format of a MAC PDU according to the present invention.

FIG. 4 illustrates the structure of a MAC PDU in an IEEE 802.16 system.

Referring to FIG. 4, the MAC PDU transmitted via a radio link is so configured that a Generic MAC Header 401 precedes Payload 403 and a Cyclic Redundancy Check (CRC) 405 follows the Payload 403.

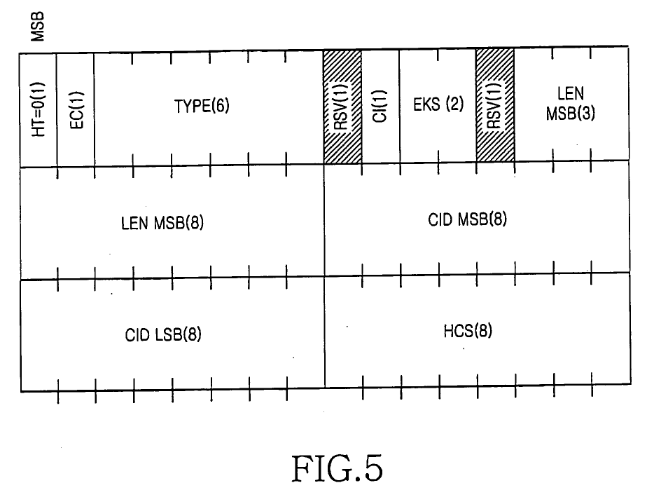

The Generic MAC Header 401 is formatted as illustrated in FIG. 5. Referring to FIG. 5, the Generic MAC Header includes a Header Type (HT) for writing header type information therein, an Encryption Control (EC) for providing encryption control information, a Type for identifying Payload, a CRC Indicator (CI) indicating the presence or absence of the CRC, an Encryption Key Sequence (EKS) for providing an encryption key sequence, a Length (LEN) indicating the length of the MAC PDU, and a Header Check Sequence (HCS) for writing a header check sequence code therein.

The MAC PDU is identified as a signaling message (e.g. a DSA message) or traffic data according to the value of the Type field.

In accordance with the present invention, when a signaling message (i.e. DSA) indicates communications between users within the same RAS, the PTPE layer 320 registers the source and destination CIDs of the users in the PTPE table. The PTPE layer 320 checks whether the CID of a MAC PDU received from the lower layer exists in the PTPE table. If the CID is found in the PTPE table, which implies communications between users within the same RAS, it writes a corresponding destination CID in the header of the MAC PDU and provides the MAC PDU to the MAC layer, instead of transferring the MAC PDU to the higher layer.

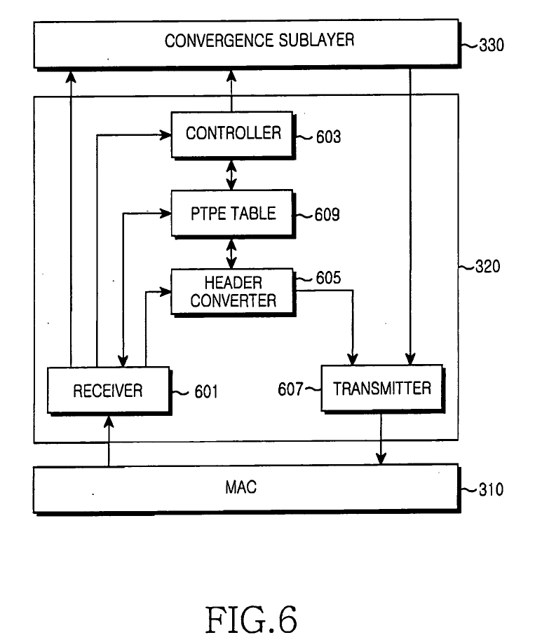

FIG. 6 is a detailed block diagram of the PTPE layer 320 according to the present invention.

Referring to FIG. 6, the PTPE layer 320 includes a receiver 601, a controller 603, a header converter 605, a transmitter 607, and a PTPE table 609.

In operation, the receiver 601 analyzes the header of a MAC PDU received from the MAC layer 310. If the analysis indicates that the MAC PDU is a DSA message, the receiver 601 provides the MAC PDU to the controller 603. If the analysis indicates that the MAC PDU is traffic, the receiver 601 determines whether the CID of the MAC PDU exists in the PTPE table 609. In the presence of the CID in the PTPE table 609, the receiver 601 provides the MAC PDU to the header converter 605 and otherwise, it provides the MAC PDU to the convergence sublayer 330.

The controller 603 analyzes the signaling message received from the receiver 601 and determines whether the destination of the MAC PDU is a user registered to the RAS, i.e. whether the MAC PDU is associated with communications between users within the same RAS. In case of communications between users within the same RAS, the controller 603 registers the source CID and destination CID of the MAC PDU in the PTPE table 609 by mapping them and then transfers the signaling message to the convergence sublayer 330. If the MAC PDU is not associated with communications between users registered to different RASs, the controller 603 sends the signaling message directly to the convergence sublayer 330. Thus, the controller 603 manages the PTPE table 609.

For example, a signaling message (DSA) defined by IEEE 802.16e includes Automatic Repeat reQuest (ARQ) and Convergence Sublayer (CS) parameters. The CS parameter indicates the IP address of a destination. Therefore, communications between users within the same RAS can be identified using the IP address of the destination of the DSA message.

The header converter 605 acquires a destination CID referring to the PTPE table 609 using the CID of the MAC PDU received from the receiver 601. The header converter 605 writes the destination CID in the header of the MAC PDU for downlink transmission and sends the MAC PDU to the transmitter 607.

The transmitter 607 transfers MAC PDUs received from the convergence sublayer 330 and MAC PDUs emulated in the PTPE layer 320 to the MAC layer 310, for downlink transmission.

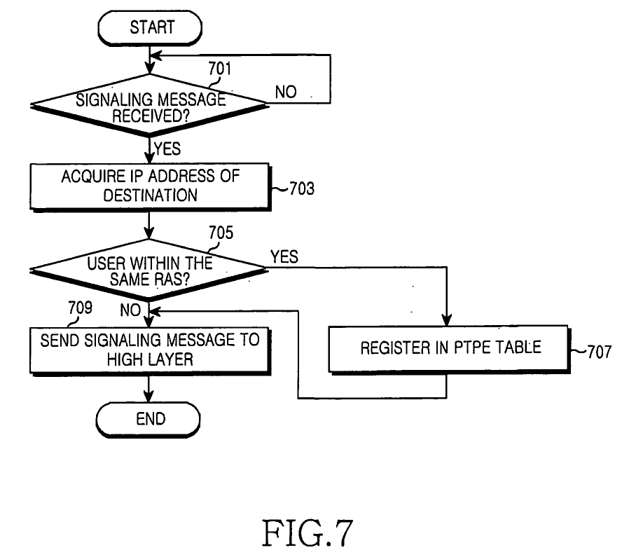

FIG. 7 is a flowchart illustrating a procedure for processing a signaling message in the PTPE layer 320 according to the present invention.

Referring to FIG. 7, the PTPE layer 320 monitors reception of a signaling message (e.g. DSA) from a lower layer (e.g. the MAC layer) in step 701. Upon receipt of the signaling message, the PTPE layer 320 acquires the IP address of a destination from the signaling message in step 703.

In step 705, the PTPE layer 320 checks whether the user of the destination is registered to the RAS, i.e. whether the signaling message is associated with communications between users within the same RAS.

In case of communications between users within the same RAS, the PTPE layer 320 maps the uplink CID of a source MS that has transmitted the signaling message to the downlink CID of the destination MS in the PTPE table 609 in step 707 and goes to step 709.

If the source MS and the destination MS are not registered to the same RAS, the PTPE layer 320 sends the signaling message to a higher layer (e.g. the convergence sublayer) in step 709 and ends the algorithm.

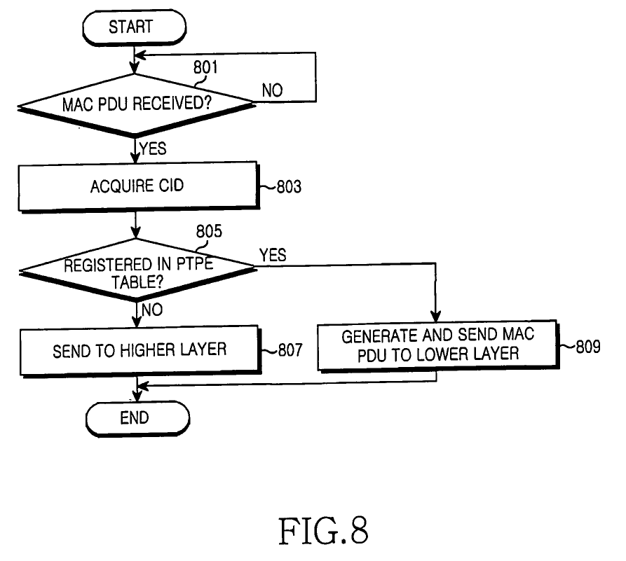

FIG. 8 is a flowchart illustrating a procedure for processing traffic in the PTPE layer 320 according to the present invention.

Referring to FIG. 8, the PTPE layer 320 monitors reception of a MAC PDU from a lower layer (e.g. the MAC layer) in step 801. Upon receipt of the MAC PDU, the PTPE layer 320 acquires a CID from the header of the MAC PDU in step 803.

In step 805, the PTPE layer 320 checks whether the CID is registered in the PTPE table 609, i.e. whether the MAC PDU is destined for another user registered to the same RAS.

In the absence of the CID in the PTPE table 609, the PTPE layer 320 just transfers the MAC PDU to a higher layer (e.g. the convergence sublayer) in step 807.

If the MAC PDU is traffic destined for another user registered to the same RAS, the PTPE layer 320 reads a destination CID corresponding to the CID from the PTPE table 609, writes the destination CID in the header of the MAC PDU, and provides the MAC PDU to the lower layer in step 809.

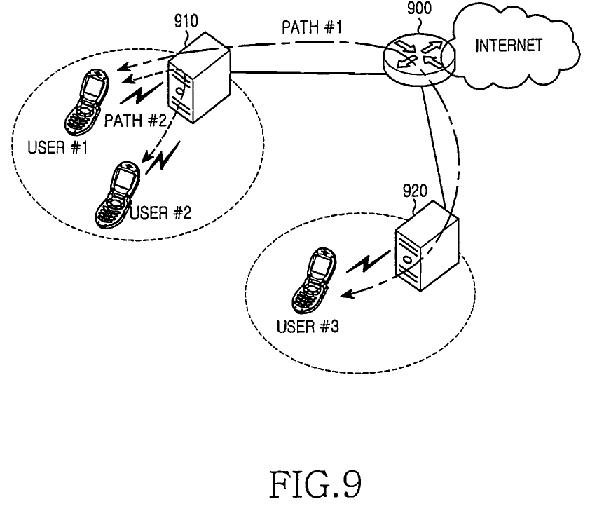

FIG. 9 illustrates communication paths between users in the broadband wireless communication system according to the present invention.

Referring to FIG. 9, User #1 and User #2 have been registered to a first RAS 910, while User #3 has been registered to a second RAS 920. User #1 and User #3 belonging to different RASs communicate with each other in Path #1 running between them through the first RAS 910, a router 900, and the second RAS 920. User #1 and User #2 belonging to the same RAS communicate with each other in Path #2 running between them through the first RAS 910. In this way, users registered to the same RAS conduct communications via the RAS alone without intervention from a higher-layer router.

Regarding setup of Path #2, User #1 and User #2 perform IEEE 802.16 network entry and then a DSA procedure for data transmission. When User #1 request DSA, User #1 notifies the first RAS 910 of the IP address of User #2 as a destination. The first RAS 910 determines whether User #2 is registered to the first RAS 910 by searching its PTPE table. Because User #2 is registered to the first RAS 910, the first RAS 910 maps the uplink CID of User #1 (a source ID) to the downlink CID of User #2 (a destination CID) in the PTPE table (Table 2). Then upon receipt of traffic data destined for User #2 from User #1, the first RAS 910 converts the header of the traffic data using the PTPE table and sends the traffic data to the User #2 on the downlink, instead of forwarding the traffic data to a higher-layer router.

In accordance with the present invention as described above, in the case of communications between users registered to the same RAS, a communication path is efficiently established between them by sending traffic data directly to a destination through point-to-point emulation in the RAS, without forwarding the traffic data to a higher-layer router (access router). The resulting prevention of an unnecessary traffic increase between the RAS and the router leads to a guarantee of the QoS of real-time traffic such as voice.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A communication apparatus in a radio access station (RAS) in a wireless communication system, comprising:
a medium access control (MAC) layer for extracting a MAC packet data unit (PDU) from uplink data received from a physical layer and transmitting the MAC PDU; and
an emulation layer for receiving the MAC PDU and for identifying a destination of the MAC PDU, and if the MAC PDU is associated with communications between terminals registered to the same RAS, converting a header of the MAC PDU, and transmitting the MAC PDU with the converted header to the MAC layer, for transmission to the destination terminal.

2. The communication apparatus of claim 1, wherein the emulation layer comprises:
a database for managing a connection identifier (CID) of a source terminal and a CID of a destination terminal for communications between terminals registered to the RAS by mapping the CID of the source terminal to the CID of the destination terminal; and
a header converter for converting the header of the MAC PDU using the database, if the MAC PDU is associated with communications between terminals registered to the same RAS.

3. The communication apparatus of claim 2, wherein the emulation layer further comprises a controller for analyzing a signaling message received from the MAC layer, and if it is determined that a destination is a terminal registered to the RAS according to the analysis, mapping a CID of a source terminal that sent the signaling message to a CID of the destination terminal in the database.

4. The communication apparatus of claim 2, wherein the emulation layer further comprises a receiver for determining whether a CID written in the MAC PDU received from the MAC layer is registered in the database, transmitting the MAC PDU to the header converter if the CID is registered in the database, and transmitting the MAC PDU to a higher layer, if the CID is not registered in the database.

5. The communication apparatus of claim 2, wherein the emulation layer further comprises a transmitter for transmitting to the MAC layer a MAC PDU with a header converted by the header converter and a MAC PDU received from the higher layer.

6. The communication apparatus of claim 3, wherein the signaling message is a dynamic service add (DSA) message.

7. A communication apparatus in a radio access station (RAS) in a wireless communication system, comprising:
a database for managing an identifier (ID) of a source terminal and an ID of a destination terminal for communications between terminals registered to the RAS by mapping the ID of the source terminal to the ID of the destination terminal; and
a header converter for, upon receipt of traffic data from the source terminal, converting a header of the traffic data using the database to transmit the traffic data to the destination terminal on a downlink.

8. The communication apparatus of claim 7, further comprising a controller for analyzing a signaling message received from a terminal, and if it is determined that a destination terminal is registered to the RAS according to the analysis, mapping an ID of the source terminal that sent the signaling message to an ID of the destination terminal in the database.

9. The communication apparatus of claim 7, further comprising a receiver for determining whether an ID written in the traffic data received from the terminal is registered in the database, transmitting the traffic data to the header converter if the ID is registered in the database, and transmitting the traffic data to a higher layer, if the ID is not registered in the database.

10. The communication apparatus of claim 7, further comprising a transmitter for transmitting to a lower layer traffic data with a header converted by the header converter and traffic data received from the higher layer.

11. The communication apparatus of claim 7, wherein the traffic data is a medium access control packet data unit (MAC PDU).

12. The communication apparatus of claim 7, wherein the IDs are connection IDs (CIDs).

13. The communication apparatus of claim 8, wherein the signaling message is a dynamic service add (DSA) message.

14. A communication method in a radio access station (RAS) in a wireless communication system, comprising the steps of:
registering an identifier (ID) of a source terminal and an ID of a destination terminal in a database by mapping the ID of the source terminal to the ID of the destination terminal, for communications between terminals registered to the RAS; and
converting, upon receipt of traffic data from the source terminal, a header of the traffic data using the database, for transmission on a downlink to the destination terminal.

15. The communication method of claim 14, wherein the registration step comprises:
analyzing a signaling message received from a terminal and determining according to the analysis whether a destination terminal is a terminal registered to the RAS;
mapping the ID of the source terminal to the ID of the destination terminal in the database, if the destination terminal is registered to the RAS.

16. The communication method of claim 14, wherein the header conversion step comprises:
determining, upon receipt of traffic data from a terminal, whether an ID written in the traffic data is registered in the database;
acquiring an ID of a destination terminal from the database, if the ID is registered in the database; and
converting a header of the traffic data using the ID of the destination terminal.

17. The communication method of claim 16, further comprising, if the ID is not registered in the database, transmitting the traffic data to a higher-layer system of the RAS.

18. The communication method of claim 14, further comprising transmitting on a downlink the traffic data with the converted header to the destination terminal.

19. The communication method of claim 14, wherein the traffic data is a medium access control packet data unit (MAC PDU).

20. The communication method of claim 14, wherein the IDs are connection IDs (CIDs).

21. The communication method of claim 15, wherein the signaling message is a dynamic service add (DSA) message.

22. A communication method in a radio access station (RAS) having a database for managing an identifier (ID) of a source terminal and an ID of a destination terminal for communications between terminals registered to the same RAS by mapping the ID of the source terminal to the ID of the destination terminal, comprising the steps of:
acquiring, upon receipt of traffic data from a terminal, an ID from the traffic data;
determining whether the ID is registered in the database;
acquiring an ID of a destination terminal to communicate with the terminal from the database, if the ID is registered in the database; and
writing the ID of the destination terminal in the traffic data and transmitting the traffic data to the destination terminal on a downlink.

23. The communication method of claim 22, further comprising transmitting the traffic data to a higher-layer system of the RAS, if the ID is not registered in the database.

24. The communication method of claim 22, further comprising:
acquiring, upon receipt of a signaling message form a terminal, an Internet protocol (IP) address of a destination terminal from the signaling message;
determining whether the destination terminal is registered to the RAS using the IP address; and
registering an ID of the terminal and an ID of the destination terminal in the database by mapping the ID of the terminal to the ID of the destination terminal, if the destination terminal is registered to the RAS.

25. The communication method of claim 22, wherein the traffic data is a medium access control packet data unit (MAC PDU).

26. The communication method of claim 22, wherein the IDs are connection IDs (CIDs).

27. The communication method of claim 22, wherein the signaling message is a dynamic service add (DSA) message.

28. A wireless communication system, comprising:
a medium access control layer for extracting a medium access control packet data unit; and
an emulation layer for receiving the medium access control packet data unit from the medium access control layer and for identifying a destination of the medium access control packet data unit, and if the medium access control packet data unit is associated with communications between terminals registered to the same radio access station, converting a header of the medium access control packet data unit, and transmitting the medium access control packet data unit with the converted header to the medium access control layer, for transmission to the destination terminal.

29. A wireless communication system, comprising:
a database for managing an identifier of a source terminal and an identifier of a destination terminal for communications between terminals by mapping the identifier of the source terminal to the identifier of the destination terminal; and
a header converter for, upon receipt of traffic data from the source terminal, converting a header of the traffic data using the database to transmit the traffic data to the destination terminal.
